(19) United States
(12) Patent Application Publication
(10) Pub. No.: US 2013/0092251 A1
(43) Pub. Date: Apr. 18, 2013

(54) Passive Fireproofing System for Pipelines

(71) Applicant: Herbert Munzenberger, Wiesbaden (DE)

(72) Inventor: Herbert Munzenberger, Wiesbaden (DE)

(21) Appl. No.: 13/566,773

(22) Filed: Aug. 3, 2012

(30) Foreign Application Priority Data
Aug. 3, 2011 (DE) 102011080330.0

(51) Int. Cl. F16L 57/04; D03D 9/00; F28F 7/00; F16L 59/14

(52) U.S. Cl. CPC F16L 57/04; F16L 59/145; D03D 9/00; F28F 7/00
USPC 137/334; 442/1; 428/596; 165/46

(57) ABSTRACT

A procedure is described for extending the period of time during which a line leg (e.g., a pipeline) made of a material with a coefficient of thermal conductivity λ_{R}, in a fireproofing installation remains below a critical temperature and hence for increasing the T-rating value according to ASTM E814 (UL1479). A line leg is wrapped with a mesh, that includes a non-flammable material with a coefficient of thermal conductivity λ_{G}, directly adjacent to the bulkheading of a feedthrough opening in a component on both sides for wall feedthroughs and/or above the feedthrough opening for ceiling feedthroughs, subject to the condition that the coefficient of thermal conductivity λ_{G} is greater than the coefficient of thermal conductivity λ_{G}. The heat removal from a line leg can be supported easily and, in particular, applied on-site such that even line legs with good thermal conductivity can achieve a high T-rating value in the fire test.

### CROSS-REFERENCE TO RELATED APPLICATIONS/INCORPORATION BY REFERENCE

The present application claims priority to German Patent Application No. DE 10 2011 080 330.0, filed Aug. 3, 2011, which is hereby incorporated by reference in its entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Openings are provided in components in order to lead line legs such as conduits (e.g., cables) or pipelines through components such as walls, ceilings, etc. In many countries, the set-up of so-called fireproofing areas is required by law for special buildings including public buildings, hospitals, schools, etc. This is aimed at preventing the fire and the associated flue gases from spreading rapidly through the entire building in case of fire. Therefore, the openings must be sealed fire-proof and flue gas-proof to prevent the fire or flue gas from passing through the opening. A number of devices for the fire-proof and flue gas-proof feedthrough of a line leg through an opening created in a component having an elastic sealing body that contains at least one feedthrough opening have been disclosed.

A fire can spread by flames sparking over to a different room or a different floor. However, even if no flames spark over, fire can still develop in a room if the heat on the side of the wall facing away from the fire rises in temperature to the point where combustible materials self-ignite. In particular, pipelines made of materials with good thermal conductivity such as steel and metal pipes are a problem in this respect. They heat up as a result of the fire on one side of the component and conduct the heat through the component in spite of potentially available fireproofing devices, such as fireproof bulkheads, in such a way that the pipeline on the side of the component facing away from the fire heats up within a short period of time to the point where the flash point of adjacent materials, such as wallpaper, curtains, etc., can be reached. If this is the case, it can result in ignition and hence a fire is started on the side facing away from the fire.

In the United States, compliance with so-called T-rating limits is required increasingly more often for fireproofing applications in addition to the standards also common in Europe, such as the fire resistance duration of a component or bulkhead. In the United States, fireproofing systems are ASTM E814 (UL 1479)-tested, whereby two ratings are tested, namely the so-called F-rating and the T-rating. The F-rating defines the minimum period during which a fireproofing installation was tested and it was demonstrated that the fire was prevented from spreading. The T-rating indicates the period within which the temperature of a measured point on an installation on the side of a wall or ceiling opening facing away from the fire rises by 180K compared to the starting temperature. The temperature of 180K above room temperature or ambient temperature is also known as the critical temperature. This ensures that the temperature on the side facing away from the fire does not reach the flash point of any materials on that side of the wall, thus preventing self-ignition due to increased temperature.

In the event of a fire, the sealing bodies, masses or collars used for bulkheading the feedthroughs of non-metallic sealable line legs only prevent the toxic flue gases and the fire from spreading into the adjacent room. Moreover, hot air can be prevented from passing through the feedthrough or from being transported into the other room through the line legs.

Especially for feedthroughs of non-insulated line legs, in particular, pipes or conduits such as metal pipes through walls and ceilings, this cannot be realized without additional procedures, because the metal pipes or conduits transmit the heat through the bulkhead to the other side of the wall in spite of the bulkheading of the feedthrough due to their good thermal conductivity. As a result, the materials surrounding the pipe or adjacent to the pipe are also heated up, which can lead to the spreading of the fire when the respective ignition temperature is exceeded, in spite of the bulkheading of the feedthrough. The heat transmission through the wall or ceiling via pipelines is notable with thin walls and ceilings such as retroactively installed drywalls because the wall and ceiling thickness and the material they are made of is often inadequate to remove the heat from the heated pipeline.

This can be prevented with the implementation of additional precautions aimed at either preventing the excessive heating of the line leg, for example, the pipe or conduit, or by removing the heat transported through the pipe and conduit material such that the thermal conductivity along the line leg through the bulkheading is prevented or minimized such that the temperature of the pipe or the conduit on the side facing away from the fire does not reach the flash point of the adjacent materials.

Excessive heating can be prevented by enveloping the pipe or conduit with a non-flammable insulation layer such as described, for example, in United States Patent Publication No. 2006/0096207 A1. United States Patent Publication No. 2006/0096207 A1 discloses a device for cooling a pipeline that contains a plurality of individual cooling aggregates filled with water or a different suitable cooling agent, wherein the cooling aggregates are surrounded by a collar, which in turn is provided with ventilation channels.

The disadvantage of this solution is that a separate collar and a separate cooling aggregate with a corresponding circumference are required for every pipe circumference. This considerably increases the work and material expenditures.

Another option is to provide the line leg such as the pipe or the conduit with a coating such as is common for intumescent fireproofing.

The disadvantages of coatings include that they are expensive, difficult to apply and sensitive to mechanical stress or impact, and that their thermal conductivity is relatively low. Furthermore, the activation temperature of the fireproofing additives used in the coating to create an insulating ash layer generally ranges between 250° C. and 300° C., which is generally above the critical range of 180K. The intumescence is only activated by the fireproofing additives when the critical range is exceeded.

### BRIEF SUMMARY OF THE INVENTION

Some embodiments relates to fireproofing. Some embodiments relate to a passive fireproofing system for pipelines and, in particular, for pipelines that include materials with high heat conductivity coefficients. In some embodiments, the pipelines are made of metal or materials containing metal.

In some embodiments, heat can be conducted away from the pipeline by means of a device to extend a period of time during which the temperature of the pipeline in the fireproofing installation remains below a threshold temperature (e.g., a critical temperature that is 180K above a starting temperature such as a room or ambient temperature).

### BRIEF DESCRIPTION OF SEVERAL VIEWS OF THE DRAWINGS

FIG. 1 shows a wall opening bulkheaded with fireproofing material and a pipeline (without wrapping) guided through the opening.

FIG. 2 shows a wall opening bulkheaded with fireproofing material and a pipeline with wrapping guided through the opening.

FIG. 3 shows a plot of temperature v. time for two measuring points over two embodiments.

FIG. 4 shows a plot of temperature v. time for two measuring points over two embodiments.

### DETAILED DESCRIPTION OF THE INVENTION

Some embodiments provide a universal system that is easy to handle (e.g., can be easily adjusted to the different geometries of the line legs to be enveloped) and that is easy to adjust to the designed length. Some embodiments provide a universal system that is manufactured and processed economically, is harmless to the environment in the case of a fire and meets the applicable fireproofing provision (e.g., regulations).

Some embodiments provide that a mesh that includes a non-flammable material with a high coefficient of thermal conductivity (λG) is wrapped around the line leg immediately subsequent (e.g., adjacent) to the bulkheading of the feedthrough opening in a component on both sides of wall feedthroughs and/or above the feedthrough opening of ceiling feedthroughs.

The term mesh used within the meaning of some embodiments includes a product of a plurality of intertwined strands made of flexible material (e.g., a netting-like product), in particular, tissues, and knitted fabrics and interlaced yarns, for example, made of wires. The term critical temperature used within the meaning of some embodiments means a temperature that exceeds the room or ambient temperature by more than 180K. For a room temperature of 22° C., the critical temperature would be 202° C. A fireproofing installation is a feedthrough opening bulkheaded with fireproofing materials provided in a component through which pipelines have been laid. In the process, bulkheading is the sealing of the feedthrough opening that remains after the installation of the pipeline with fireproofing material such as foam or mortar to which fireproofing additives were added, and/or a preformed foam part capable of intumescence in the form of a brick or a mat or bags filled with fireproofing material. A line leg refers to both a single line such as, for example, a pipeline or a conduit, or a bundle including two or more lines, such as, for example, pipelines or conduits.

Some embodiments provide for the use of a moldable and bendable mesh that includes a non-flammable material with a coefficient of thermal conductivity λ_{G} for extending the period of time during which a line leg (e.g., a pipeline that includes a material with a coefficient of thermal conductivity λ_{R} in a fireproofing installation) remains below a critical temperature, subject to the condition that the coefficient of thermal conductivity λ_{G} is greater than the coefficient of thermal conductivity λ_{R}. This increases or amplifies the heat-release from line legs (e.g., pipelines whose coefficient of thermal conductivity λ_{R} is smaller than the coefficient of thermal conductivity λ_{G} of the mesh) such that the period of time during which the line leg remains below a critical temperature can be extended.

Some embodiments provide that the mesh is sufficiently moldable and bendable, making it possible that it can easily, for example, without major force and hence manually and without any additional tools, be wrapped around a line leg (e.g., a pipeline). In some embodiments, the material is bendable such that it retains the shape into which it was brought after having been wrapped around a line leg. This facilitates the installation and fastening or fixation of the mesh on the line leg. Moreover, the mesh is flexible in the longitudinal and transverse direction of the line leg, enabling it to equalize heat-induced expansion differences without reducing the contact area between the mesh and the pipeline. In some embodiments, the mesh can be held with rivets or similar fasteners.

In some embodiments, the non-flammable materials include one or more of the following: stainless steel, copper, aluminum or alloys thereof. However, non-metallic fibers, for example, inorganic fibers, glass fibers, etc., coated with metals or alloys can also be used as material for the mesh. In some embodiments, copper or aluminum is used as a material for a metal mesh. Copper and aluminum are good thermal conductors, for example, coefficients of thermal conductivity: λ_{Cu} (pure)=401 W/(m·K); λ_{Cu} (commercially available)=240-380 W/(m·K); λ_{Al(99.5%)}=236 W/(m·K) and have generally advantageous properties with respect to handling and use.

In some embodiments, the coefficient of thermal conductivity λ_{G} of the material the mesh is made of should be greater than the coefficient of thermal conductivity λ_{R} of the material the line leg (e.g., the pipeline) is made of, so that the heat is conducted away from the line leg. This ensures that a sufficient amount of heat is conducted away from the line leg across the length of the line leg, in particular, the pipeline wrapped with the mesh, so that the line leg does not exceed the critical temperature directly after the mesh or that the period until which the line leg has reached the critical temperature is as long as possible.

In some embodiments, the mesh includes a surface facing away from the pipeline that is as large as possible to enable as much heat as possible to be released from the mesh into the environment. Thus, the cooling effect of the pipeline is increased.

In some embodiments, the netting width should be selected such that the optimal or designed heat conduction away from the line leg is ensured. Accordingly, the netting width should not be designed too large, or else the insulating effect and the desired function of the wrapping can no longer be substantially achieved.

In some embodiments, the thickness and length of the mesh are selected depending on the quality of the line leg such as the material (e.g., coefficient of thermal conductivity), diameter, wall strength, etc., in such a way that a sufficient amount of heat can be removed to meet the fire test requirements according to ASTM E814 (UL1479). The thickness can easily be varied by wrapping the mesh around the line leg several times. The length can be varied either by selecting a mesh with a corresponding width or simply by cutting it accordingly.

Some embodiments provide that the mesh is a type of continuous ribbon from which a piece of mesh can be cut off and further tailored, if necessary.

Some embodiments provide a method for extending the period during which a line leg, in particular, a pipeline in a fireproofing installation, remains below a critical temperature. The pipeline can include, for example, materials with a coefficient of thermal conductivity λ_{R}, wherein a line leg, in particular, a pipeline, is wrapped with a mesh that includes non-flammable material with a coefficient of thermal conductivity λ_{G} directly in front of the bulkheading of a feedthrough opening in a component, subject to the condition that the coefficient of thermal conductivity λ_{G} is greater than the coefficient of thermal conductivity λ_{R}. Hence, the method increases the T-rating value of line legs according to ASTM E814 (UL1479).

In some embodiments, line legs and, in particular, pipelines passing through wall feedthroughs, are wrapped with the mesh on both sides.

In some embodiments, for feedthroughs through ceilings, it often suffices if the line legs are wrapped with the mesh on one side (e.g., the side above the ceiling).

In some embodiments, the line leg (e.g., a pipeline) is wrapped with the mesh at such a length in an axial direction of the line leg and with such a thickness in the radial direction of the line leg that a sufficient amount of heat is removed to extend the period during which a temperature of the line leg (e.g., a pipeline) in a fireproofing installation remains below a critical temperature, and hence meets the fire test requirements according to ASTM E814 (UL1479). The length and the thickness are dependent on the quality of the line leg, such as the material (e.g., coefficient of thermal conductivity), diameter, wall strength, etc.

Some embodiments can be used for line legs including materials having a coefficient of thermal conductivity with which the heat removal via the pipe leg section (e.g., in an axial direction) which is located in the bulkheaded opening in the component is so low that the temperature of the line leg on the side facing away from the fire after the bulkheading can rise to the point where it exceeds a critical temperature and hence the fire test requirements according to ASTM E814 (UL1479) are not met if the temperature is measured with a temperature sensor attached directly on the line leg. These can be non-insulated steel or metal pipes and conduits.

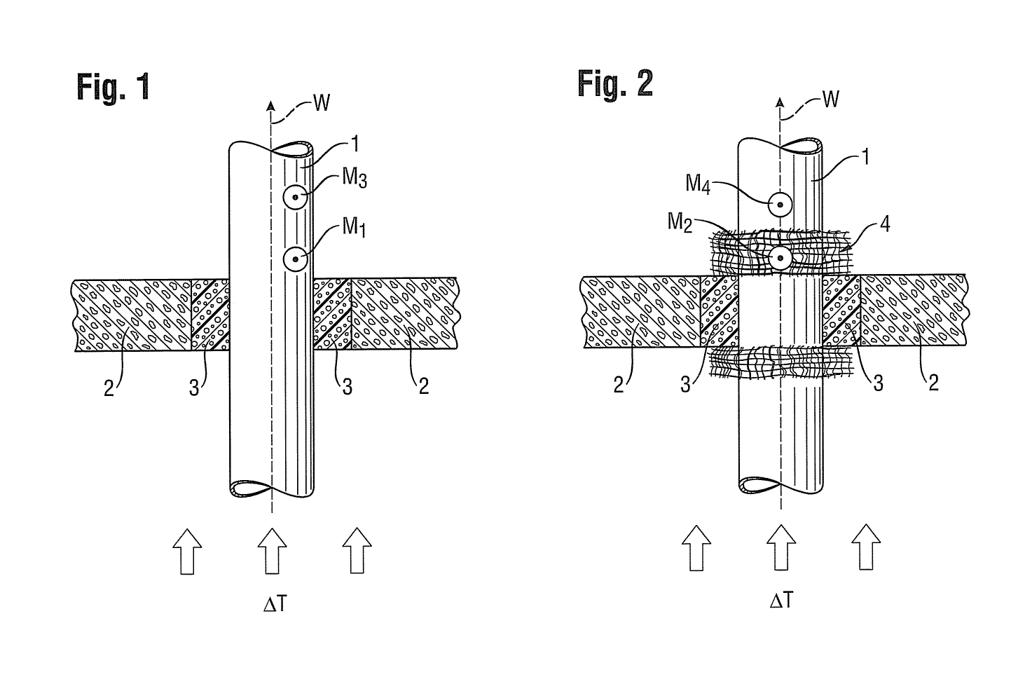

FIG. 1 shows a fireproofing installation having a pipeline (1) guided through a wall (2) through an opening. In the illustrated example, the pipeline (1) is a copper pipe with a diameter of 78 mm. The wall opening contains flue gas-proof and fireproof bulkhead with a fireproofing material (3). In so doing, the fireproofing material can be a foam or a mortar with added fireproofing additives and/or a preformed foam part capable of intumescence in the form of a brick or a mat or bags filled with fireproofing material. During the fire test, one side is exposed to the flames; in FIG. 1, this corresponds to the direction from below, indicated with thick arrows. Accordingly, the heat conduction (W) within the pipeline occurs from the fire-exposed side toward the direction of the side facing away from the fire.

During the fire test, the temperature is measured (e.g., once) directly after the wall opening, wherein a temperature sensor (M₁) is mounted directly on the pipeline (1) at an axial distance of 25 mm from the wall bulkhead and once at an additional axial distance from the wall bulkhead, wherein an additional temperature sensor (M₃) is attached directly on the pipeline (1) at an axial distance of about 250 mm from the wall bulkhead.

FIG. 2 illustrates the fireproofing installation of FIG. 1, in which the pipeline (1) is wrapped with aluminum mesh (4). The aluminum mesh has a thickness of 15 mm in the radial direction of the pipeline (1) and a length of 250 mm in the axial direction of the pipeline (1). Again, one side is exposed to the flames during the fire test; in FIG. 2, this also corresponds to the direction from below, indicated with the thick arrows. Correspondingly, the heat conduction (W) within the pipeline occurs from the fire-exposed side toward the direction of the side of the wall opening facing away from the fire.

During the fire test, the temperature is measured (e.g., once) directly after the wall bulkhead, wherein a temperature sensor (M₂) is attached directly on the wrapping (4) at an axial distance from the wall bulkhead of 25 mm, and once at an axial distance from the wall bulkhead, directly after the wrapping (4), wherein an additional temperature sensor (M₄) is attached directly on the pipeline (1) immediately after the wrapping (4).

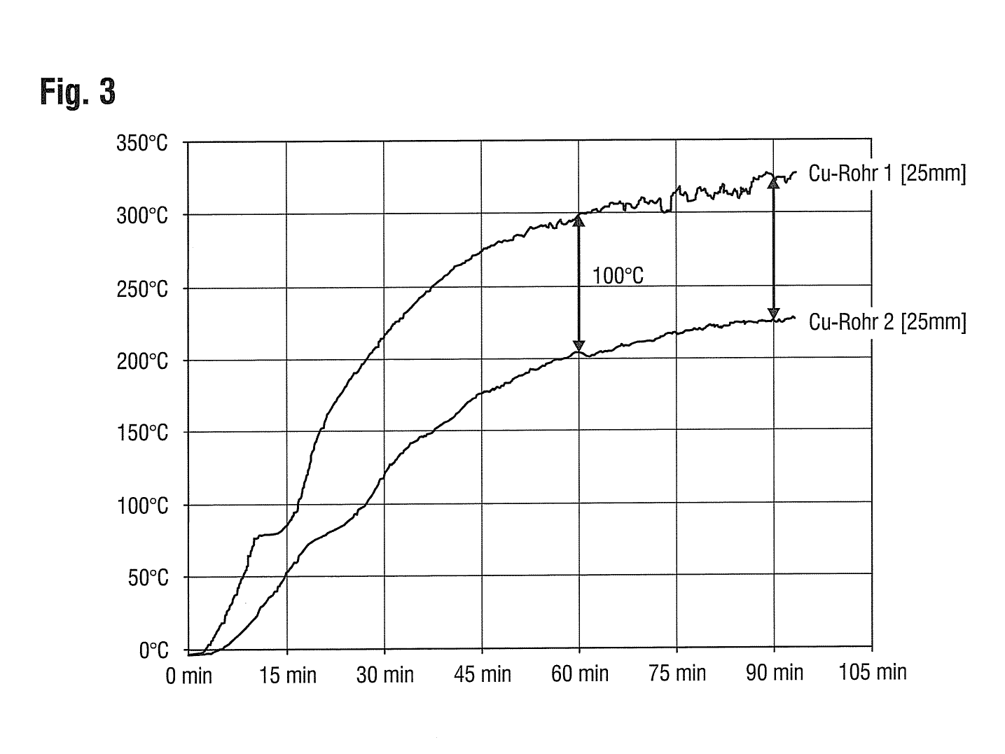

FIG. 3 shows the temperature gradient during the fire test for an estimated duration of 95 minutes at the two measuring points M₁ and M₂, positioned as described above and illustrated in FIG. 1 and FIG. 2.

As the curves in FIG. 3 demonstrate, the temperature at the measuring point M₁ (unwrapped copper pipe, 25 mm after the bulkhead) rises relatively quickly, reaching a critical temperature as early as after about 20 minutes. In contrast, a critical temperature is only reached after about 50 minutes at the measuring point M₂ (wrapped copper pipe, 25 mm after the bulkhead). After about 60 minutes, a temperature of 100° C. is recorded at both measuring points. This demonstrates that the duration within which the pipeline in the fireproofing installation remains below a critical temperature was prolonged by wrapping the pipeline with a mesh according to some embodiments.

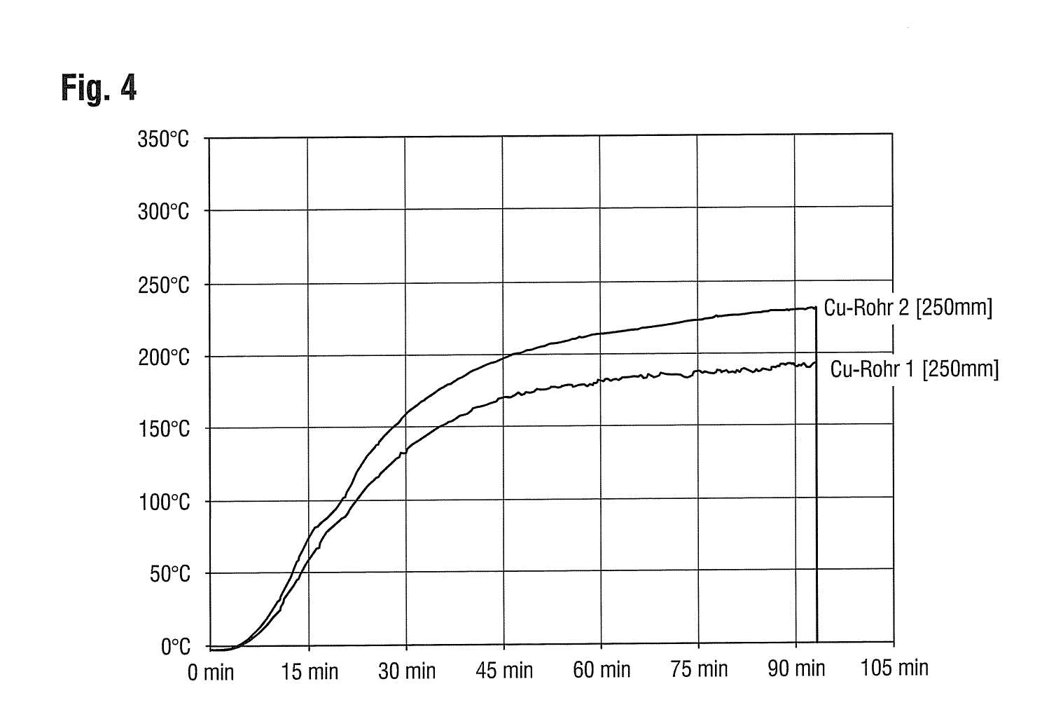

FIG. 4 shows the temperature gradient during the fire test for an estimated duration of 95 minutes at the two measuring points M₃ and M₄, positioned as described above and illustrated in FIG. 1 and FIG. 2.

As the curves in FIG. 4 demonstrate, the temperature at the measuring point M₃ (unwrapped copper pipe, 250 mm after the bulkhead) does not rise as quickly as at the measuring point M₄ (wrapped copper pipe, 250 mm after the bulkhead). This indicates that at the beginning of the fire test, for example, at low temperatures without wrapping with the mesh, the heat transfer to the environment though the blank copper pipe is better. This demonstrates that the wrapping also has a certain insulating effect, which initially, still in the uncritical range, counters the rapid heat release. The effect of the wrapping according some embodiments becomes apparent as the fire test progresses to higher temperatures. Here, the temperature rises more at measuring point M₃ than at measuring point M₄, which is due to the fact that a greater amount of heat was removed from the pipeline with the wrapping than without. This also demonstrates that the period during which the pipeline in a fireproofing installation remains below a critical temperature was extended by wrapping the pipeline with a mesh according to some embodiments.

While particular elements, embodiments, and applications of the present invention have been shown and described, it is understood that the present invention is not limited thereto because modifications may be made by those skilled in the art, particularly in light of the foregoing teaching. It is therefore contemplated by the appended claims to cover such modifications and incorporate those features which come within the spirit and scope of the present invention.

1. A mesh for extending a duration during which a line leg in a fire protection installation remains below a critical temperature, comprising:
non-flammable material having a coefficient of thermal conductivity λ_{G} that is greater than a coefficient of thermal conductivity λ_{R} of the line leg, wherein the non-flammable material is moldable and bendable.

2. The mesh according to claim 1, wherein the mesh includes one or more of the following: a tissue, knitted fabric and interlaced yarn.

3. The mesh according to claim 1, wherein the non-flammable material comprises one or more of the following: stainless steel, copper, aluminum, and an alloy.

4. The mesh according to claim 1, wherein the non-flammable material comprises aluminum.

5. The mesh according to claim 1, wherein the mesh is wrapped around the line leg.

6. The mesh according to claim 1, wherein the mesh is wrapped around the line leg such that the mesh at least extends from one or both adjacent sides of a bulkhead through which the line leg passes.

7. The mesh according to claim 1, wherein the mesh is wrapped around the line leg such that the mesh extends from above a ceiling bulkhead through which the line leg passes.

8. The mesh according to claim 1, wherein the critical temperature is 180K above an ambient temperature or room temperature before heating.

9. The mesh according to claim 1, wherein a thickness and a length of the mesh are selected depending on a quality of the line leg such that a sufficient amount of heat is conducted away to extend a period of time during which a temperature of the line leg remains below the critical temperature.

10. The mesh according to claim 1, wherein the line leg comprises a pipeline or a conduit.

11. A method for extending a period of time during which a line leg in a fireproofing installation remains below a critical temperature, comprising:
providing a mesh that includes non-flammable material having a coefficient of thermal conductivity λ_{G} that is greater than a coefficient of thermal conductivity λ_{R} of the line leg, wherein the non-flammable material is moldable and bendable; and
wrapping the mesh around the line leg.

12. The method according to claim 11, wherein the mesh is wrapped around the line leg on one or both sides directly in front of a bulkhead of a feedthrough opening in a component.

13. The method according to claim 11, wherein the mesh is wrapped around the line leg such that the mesh extends from above a ceiling bulkhead through which the line leg passes.

14. The method according to claim 11, wherein the line leg is wrapped with the mesh at such a length that a sufficient amount of heat is conducted away to keep a temperature of the line leg below a critical temperature.

15. The method according to claim 11, wherein the mesh includes one or more of the following: a tissue, knitted fabric and interlaced yarn.

16. The method according to claim 11, wherein the non-flammable material comprises one or more of the following: stainless steel, copper, aluminum, and an alloy.

17. The method according to claim 11, wherein the non-flammable material comprises aluminum.

18. The method according to claim 11, comprising:
insulating and cooling, via the mesh, the line leg.

19. The method according to claim 11, wherein the line leg comprises a pipeline or a conduit.

20. The method according to claim 11, comprising:
keeping the temperature of the line leg below the critical temperature on a side of a wall opposite from a heat source that is heating the line leg for a time that is longer than if the line leg did not have the mesh wrapped around the line leg.
